(19) United States
(12) Patent Application Publication
(10) Pub. No.: US 2025/0248881 A1
(43) Pub. Date: Aug. 7, 2025

(54) ROLLATOR

(71) Applicant: ZIJIE LIU, Zhongshan (CN)

(72) Inventors: WEIGUO LIU, Zhongshan (CN); ZIJIE LIU, Zhongshan (CN)

(21) Appl. No.: 18/668,581

(22) Filed: May 20, 2024

(30) Foreign Application Priority Data
Feb. 4, 2024 (CN) 202410159541.2

(51) Int. Cl. A61H 3/04

(52) U.S. Cl. CPC A61H 3/04; A61H 2003/046; A61H 2201/0161

(57) ABSTRACT

A rollator is provided, which includes a front wheel bracket, a rear wheel bracket, at least one seat assembly configured for a user to ride on, and a connection mechanism connected between the front wheel bracket and rear wheel bracket and configured for the seat assembly to be detachably connected; the seat component can be flipped around the connection mechanism to drive the front wheel bracket to move towards the rear wheel bracket and be folded onto the rear wheel bracket. Through detachable connection and flipping design of the seat component, the rollator can achieve a compact folding by moving the front wheel bracket towards the rear wheel bracket and being folding onto the rear wheel bracket. This folding way can render the rollator to occupy a small space when not in use, and it is convenient to carry and store.

### CROSS-REFERENCE TO RELATED APPLICATIONS

This application claims priority to Chinese Patent Application No. 202410159541.2, filed on Feb. 4, 2024, which is hereby incorporated by reference in its entirety.

### TECHNICAL FIELD

The present disclosure relates to the field of medical device technologies, and in particular, to a rollator.

### BACKGROUND

Rollator is a tool vehicle used to assist walking, especially suitable for elderly people who have difficulty walking or those with injured legs and feet who are difficult to walk.

In existing foldable rollator designs, there are mainly two folding wats. One way is to fold left and right frames through a connected X-shaped connection rod, which requires a significant amount of time and effort during folding. Due to the fact that this folding way by the X-shaped connection rod usually requires multiple clamping components to stabilize the stability of the frame during use, which increases the difficulty for a user to fold and unfold the rollator. Especially for people with limited mobility, this folding way is almost difficult to operate. Another folding way is to fold the front and rear frame, as in application number of 201720644015.0, which discloses a rollator. It can be seen that a gravity center after folding is unstable. Although this way is simple, the folded frame cannot park smoothly on the ground and usually needs to be matched with clamping components to maintain stability, which brings out great inconvenience to the user.

Besides, the inconvenience of folding way, there are also stability issues with existing foldable rollators. The folding way by the X-shaped connection rod requires multiple clamping components to stabilize the stability of the frame during use, and the folding way by the front and rear frames also requires additional clamping components to stabilize the frame. These clamping components not only increase weight and complexity of the rollator, but may also lead to instability and safety hazards during use.

Therefore, the existing foldable rollators have certain inconveniences and shortcomings in terms of folding ways and stability, further technological improvements and innovations are needed to solve these issues. For people with limited mobility, a more stable design that is simple and easy to fold will greatly improve life quality and convenience. Therefore, seeking a new folding way and a more stable design scheme has become an urgent need for foldable rollator design.

### SUMMARY

The present application aims to address certain inconveniences and deficiencies in the folding way and stability of a foldable rollator in existing technology, and provides a more stable rollator that is simple and easy to fold.

A rollator, which includes:
a front wheel bracket;
a rear wheel bracket;
at least one seat assembly, configured for a user to ride on; and
a connection mechanism connected between the front wheel bracket and rear wheel bracket, configured for the seat assembly to be detachably connected; where the seat assembly is capable of flipping around the connection mechanism to drive the front wheel bracket to move towards the rear wheel bracket and be folded onto the rear wheel bracket.

In an embodiment of the present disclosure, the connection mechanism includes a first connection rod, a second connection rod, and an installation plate; the first connection rod is hinged on the front wheel bracket; one end of the second connection rod is hinged on the rear wheel bracket and the other end thereof is hinged on the first connection rod; the installation plate is provided on the first connection rod and configured to connect the seat assembly; the first connection rod is driven to flip forward around the front wheel bracket by the seat assembly, and the second connection rod is driven to reverse backward to fold the front wheel bracket onto the rear wheel bracket by the seat assembly, the first connection rod abuts against the rear wheel bracket after being folded.

In an embodiment of the present disclosure, a length of the first connection rod is longer than a length of the second connection rod.

In an embodiment of the present disclosure, the rear wheel bracket includes a rear wheel frame body, a first roller hinged on the rear wheel frame body, a connection kit sleeved on the rear wheel frame body and configured for the front wheel bracket to be hinged, and a handlebar assembly configured to be inserted forward or backward on the connection kit.

In an embodiment of the present disclosure, one side of the connection kit away from the front wheel bracket is hinged with a positioning member so as to lock the handlebar assembly, the handlebar assembly is provided with a plurality of positioning holes configured for the positioning member to insert; the connection kit is further provided with a through hole configured for the positioning member to pass through, and the positioning member runs through the through hole and is connected to the positioning holes; the connection kit includes a hinge part configured for the front wheel bracket to be hinged and an insertion part configured for the handlebar assembly to pass through, where the handlebar assembly is capable to detachably insert onto the connection kit in forward or reverse direction and move up and down relative to the connection kit.

In an embodiment of the present disclosure, the rollator further includes a backrest assembly and an armrest assembly, two sides of the connection kit are further provided with a backrest connection part configured for the backrest assembly to be connected and an armrest connection part configured for the armrest assembly to be connected.

In an embodiment of the present disclosure, the backrest assembly includes a backrest and a first installation part provided at two ends of the backrest, the first installation part is detachably connected to the backrest connection part.

In an embodiment of the present disclosure, the armrest assembly includes a handrail and a second installation part provided at one end of the handrail, the second installation part is detachably connected to the armrest connection part.

In an embodiment of the present disclosure, the front wheel bracket is further provided with a foot pedal configured for the user to step on.

In an embodiment of the present disclosure, the seat assembly further includes a dining plate provided on the armrest assembly.

In an embodiment of the present disclosure, the seat assembly further includes a cushion plate provided on an upper of the installation plate, and a cushion covered on an upper of the cushion plate, where the dining plate is detachably provided between the cushion and the cushion plate.

Compared with existing technology, the beneficial effects of the present application are as follows:
a rollator is provided by the present application, which can achieve a compact folding through detachable connection and flipping design of the seat component. The front wheel bracket is moved towards the rear wheel bracket and folded onto the rear wheel bracket. This folding way can render the rollator to occupy a small space when not in use, it is convenient to carry and store. Due to the compact folding of the rollator, a user can easily carry it to different locations. The compact folding structure also renders the storing of the rollator more convenient. The folded rollator frame can be stably parked on the ground, which is convenient to operate and does not require too many clamping components.

### BRIEF DESCRIPTION OF DRAWINGS

In order to provide a clearer explanation of the technical solution in the embodiments of the present application, a brief introduction will be given below to the accompanying drawings required in the description of the embodiments.

FIG. 1 is a three-dimensional schematic diagram of a rollator of the present application.

FIG. 2 is a schematic diagram of another assembly way for the rollator of the present application.

FIG. 3 is a diagram of a handlebar reversely assembled and a disassembly of a dining plate for the rollator of the present application.

FIG. 4 is a cross-sectional view at A-A of the rollator in an unfolded state of the present application.

FIG. 5 is a cross-sectional view at A-A of the rollator in a folding state of the present application.

FIG. 6 is a schematic diagram of an assembly state of the dining plate for the rollator of the present application.

FIG. 7 is a three-dimensional schematic diagram of a connection kit for the rollator of the present application.

FIG. 8 is a schematic diagram of a disassembly of an armrest assembly for the rollator of the present application.

FIG. 9 is a schematic diagram of the disassembly of the armrest assembly from another perspective for the rollator of the present application.

FIG. 10 is a schematic diagram of the disassembly of a backrest assembly for the rollator of the present application.

FIG. 11 is a schematic diagram of the disassembly of a handlebar assembly for the rollator of the present application.

FIG. 12 is a schematic diagram of a disassembly of a front wheel bracket for the rollator of the present application.

### DESCRIPTION OF EMBODIMENTS

The following is a further explanation of the present disclosure in combination with the accompanying drawings:

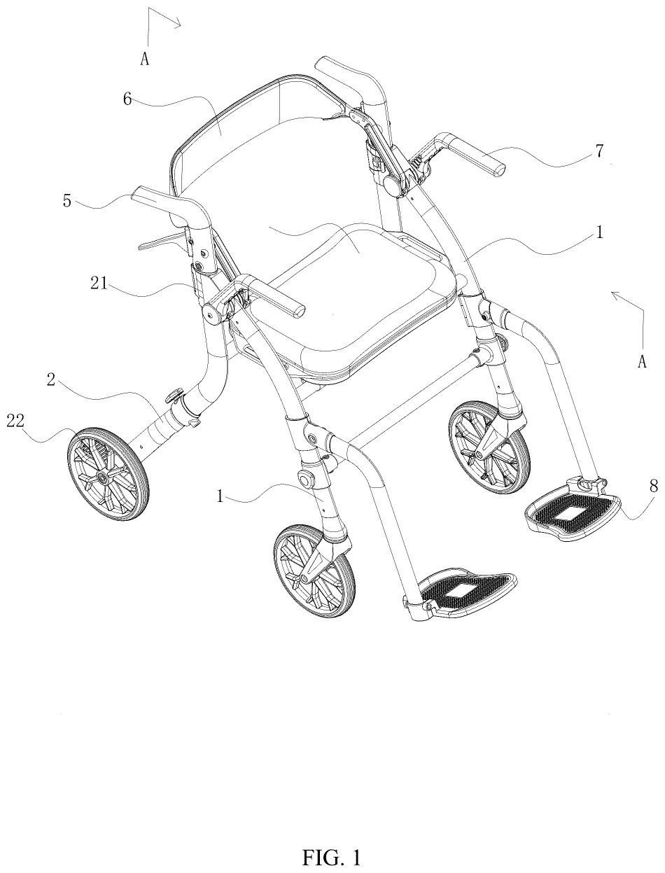

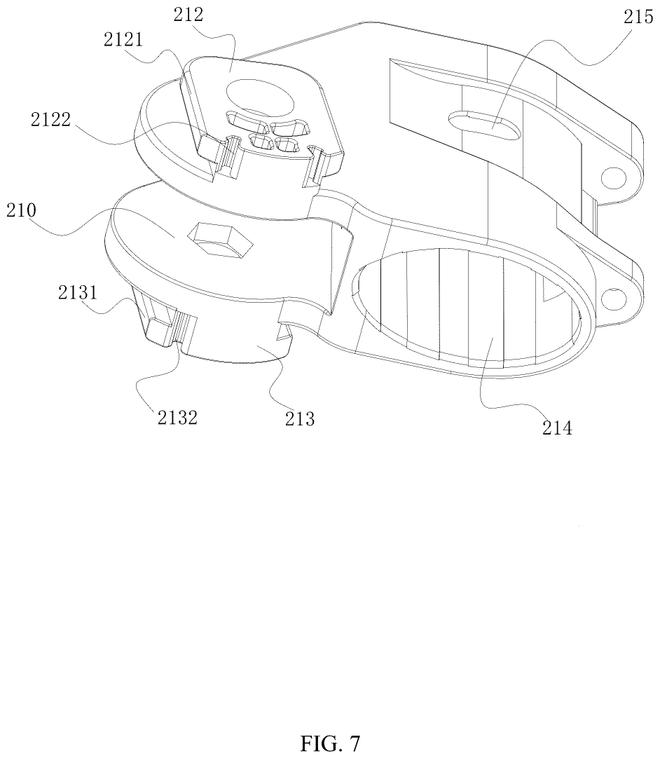

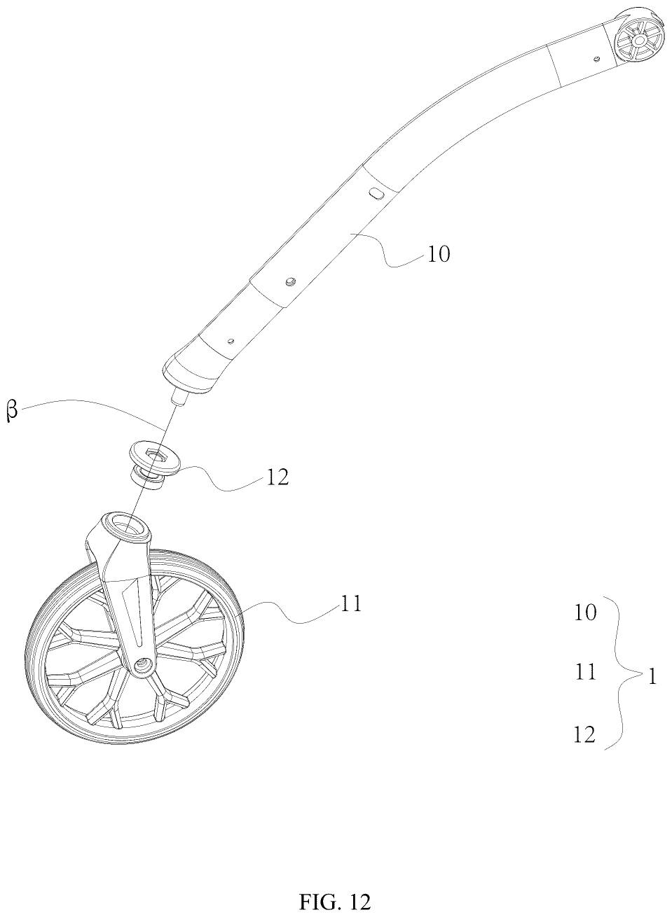

As shown in FIGS. 1-12, a rollator includes a front wheel bracket 1, a rear wheel bracket 2, a seat assembly 3, a connection mechanism 4, a handlebar assembly 5, a backrest assembly 6, an armrest assembly 7, a foot pedal 8, a first connection rod 41, a second connection rod 42, an installation plate 43, a rear wheel frame body 20, a connection kit 21, a first roller 22, a positioning hole 50, a positioning member 211, a backrest connection part 212, and an armrest connection part 213.

A rollator, including:
a front wheel bracket 1, a rear wheel bracket 2;
at least one seat assembly 3, configured for a user to ride on;
a connection mechanism 4 connected between the front wheel bracket 1 and the rear wheel bracket 2, configured for the seat assembly 3 to be detachably connected; the seat assembly 3 can flip around the connection mechanism 4 to drive the front wheel bracket 1 to move towards the rear wheel bracket 2 and be folded onto the rear wheel bracket 2. Through detachable connection and flipping design of the seat assembly, the rollator can achieve a compact folding. The front wheel bracket can be moved towards the rear wheel bracket and folded onto the rear wheel bracket. This folding way can render the rollator to occupy a small space when not in use, it is convenience to carry and store. As the rollator can be compactly folded, the user can more conveniently carry the rollator to different locations; for example, traveling or visiting medical institutions, and for people with limited living space, this compact folding structure also renders the storage of rollator more convenient.

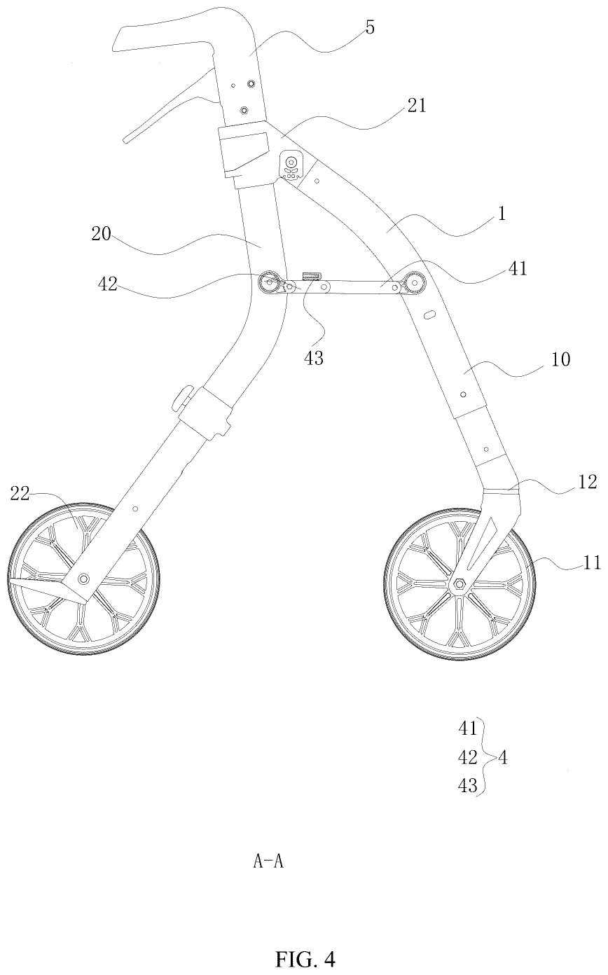

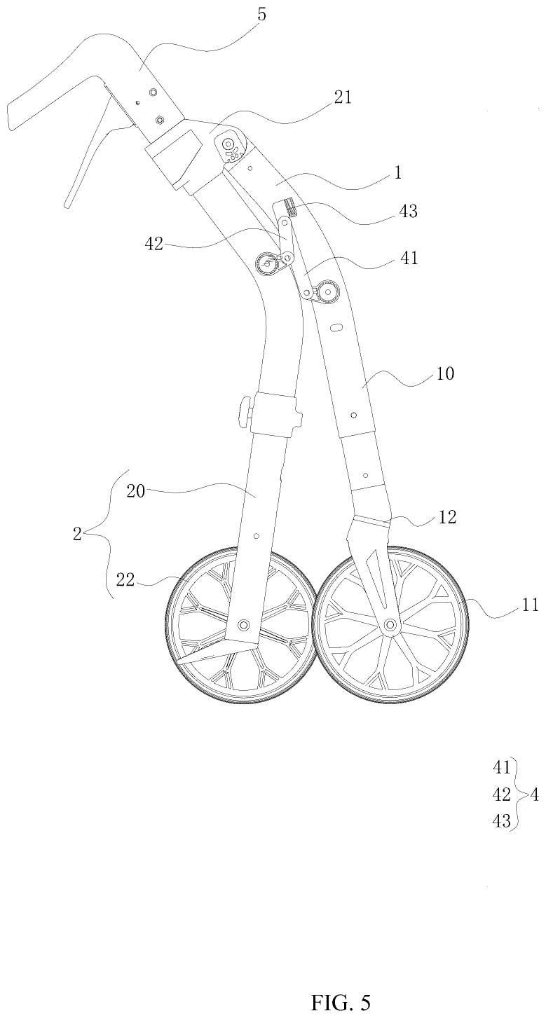

In an implementation, as shown in FIGS. 4 and 5, the connection mechanism 4 includes a first connection rod 41, a second connection rod 42, and an installation plate 43; the first connection rod 41 is hinged on the front wheel bracket 1, one end of the second connection rod 42 is hinged on the rear wheel bracket 2, and the other end thereof is hinged on the first connection rod 41, the installation plate 43 is provided on the first connection rod 41 and configured to connect the seat assembly 3. The first connection rod 41 can be driven to flip forward around the front wheel bracket 1 by the seat assembly 3, and the second connection rod 42 is also driven to reverse backward to fold the front wheel bracket 1 onto the rear wheel bracket 2 by the seat assembly 3. After folding, the first connection rod 41 abuts against the rear wheel bracket 2. The hinge design of the first connection rod 41, the second connection rod 42, and the installation plate 43 allows the seat assembly 3 to drive the first connection rod 41 to flip around the front wheel bracket 1 and drive the second connection rod 42 to reverse backwards, so the front wheel bracket 1 is folded onto the rear wheel bracket 2. This design can ensure stability during folding and unfolding process, thereby avoiding unstable situations. Due to the design of the connection mechanism 4, the front wheel bracket 1 can be stably folded onto the rear wheel bracket 2, so there is no need for additional clamping components to maintain stability. This reduces complexity and weight of the rollator, and also reduce instability and safety hazards during use. The design of the connection mechanism 4 renders the folding and unfolding process of the rollator more stable and controllable, allowing the user to easily complete these operations and improving the usability of the rollator.

In an implementation, a length of the first connection rod 41 is longer than that of the second connection rod 42. It is unexpectedly discovered that when the length of the first connection rod is longer than that of the second connecting rod, the folded rollator can be placed smoothly on a flat surface. When the length of the second connection rod is ⅓ to ½ of the length of the first connecting rod, the folded rollator can be placed smoothly on the flat surface. If the lengths of the two connection rods are equal or similar, the front wheel bracket cannot be folded smoothly on the rear wheel bracket without a use of clamping components, and a roller of the front wheel bracket will slide forward. Only when the length of the second connection rod is ½ of the length of the first connecting rod, the rollator can stand smoothly on the flat surface, this is because when the length of the second connection rod is ½ of the length of the first connecting rod, the first connection rod will drive the second connection rod to rotate upwards around a hinge joint, until the first connection rod abuts against the rear wheel bracket, a gravity center of the front wheel bracket is exactly on the second connection rod and the rear wheel bracket, and a balance of gravity center reaches a smooth parking effect.

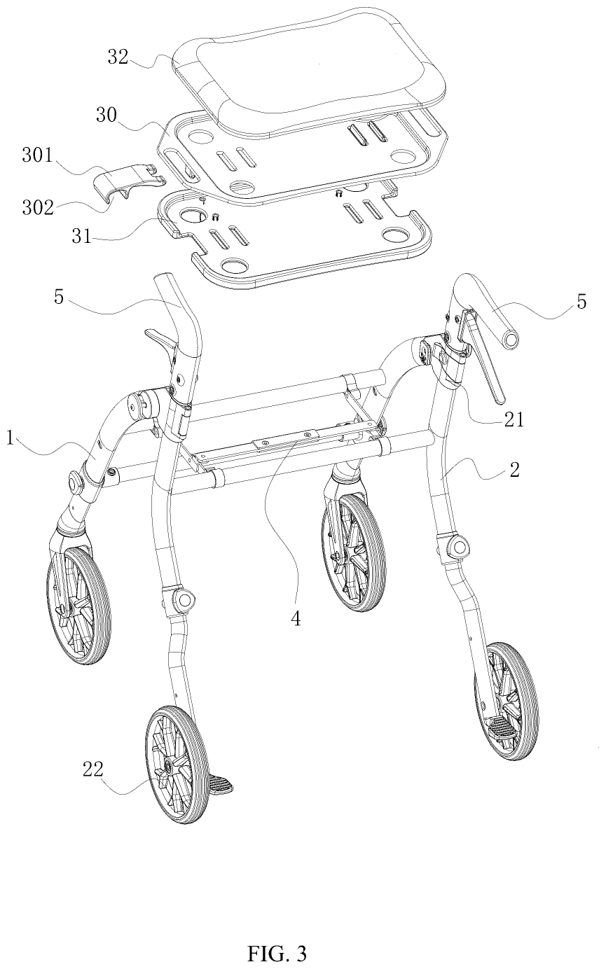

In an implementation, the rear wheel bracket 2 includes a rear wheel frame body 20, a first roller 22 hinged on the rear wheel frame body 20, a connection kit 21 sleeved on the rear wheel frame body 20 and configured for the front wheel bracket 1 to be hinged, and a handlebar assembly 5 configured to be inserted forward or backward on the connection kit 21, as shown in FIG. 3. By providing with a detachable handlebar assembly, the handlebar assembly can be inserted forward or backward on the connection kit. When the user has difficulty moving due to hemiplegia or other conditions, only one arm of the user can exert force, which will result in a shift in the gravity center of the user. This embodiment shows that when the user's body gravity center shifts to a right side, the handlebar assembly on a left side can be disassembled and changed in an opposite direction, then it will be more convenient to use, thereby reducing required components, lowering a production cost, and being convenient for the user with only one arm to use.

In an implementation, one side of the connection kit 21 away from the front wheel bracket 1 is hinged with a positioning member 211 so as to lock the handlebar assembly 5. The handlebar assembly 5 is provided with a plurality of positioning holes 50 configured for the positioning member 211 to be inserted. The connection kit 21 is further provided with a through hole 215 configured for the positioning member 211 to pass through. The positioning member 211 can run through the through hole 215 and be connected to the positioning hole 50. The connection kit 21 includes a hinge part 210 configured for the front wheel bracket 1 to be hinged and an insertion part 214 configured for the handlebar assembly 5 to be inserted. The handlebar assembly 5 is detachably inserted on the connection kit 21 in forward or reverse direction and can move up and down relative to the connection kit 21.

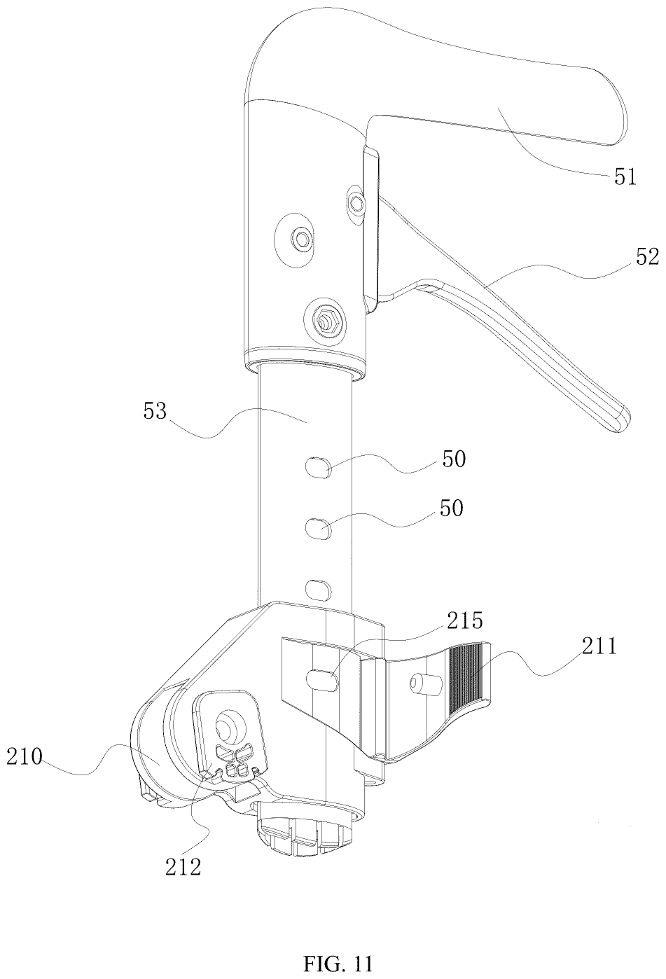

In an implementation, as shown in FIG. 11, the handlebar assembly 5 includes a handlebar 51, a positioning rod 53 provided at a lower of the handlebar 51, and a brake member 52 hinged on the handlebar 51. The plurality of positioning holes 50 are arranged to be spaced on the positioning rod 53, the positioning rod 53 runs through the insertion part 214 and can slide relative to the insertion part 214. By providing with a handlebar that is detachable and can adjust a height, it is convenient to position according to the user's height and to facilitate forward or reverse installation settings according to the use's usage situation.

In an implementation, the rollator further includes a backrest assembly 6 and an armrest assembly 7. Two sides of the connection kit 21 are further provided with a backrest connection part 212 configured for the backrest assembly 6 to be connected and an armrest connection part 213 configured for the armrest assembly 7 to be connected. In an implementation, the backrest connection part 212 further includes a first flange 2121 that extends circumferentially, and the armrest connection part 213 further includes a second flange 2131 that extends circumferentially. The backrest assembly 6 is provided with a first slide rail 62 that matches with and is connected to the first flange 2121 corresponding to the first flange 2121. The armrest assembly 7 is provided with a second slide rail 72 that matches with and is connected to the second flange 2131 corresponding to the second flange 2131, which facilitates the user to insert the backrest assembly 6 and armrest assembly 7 onto the backrest connection part 212 and armrest connection part 213, and through a fit between the slide rail and the flange, an effect of convenient disassembly and assembly is achieved.

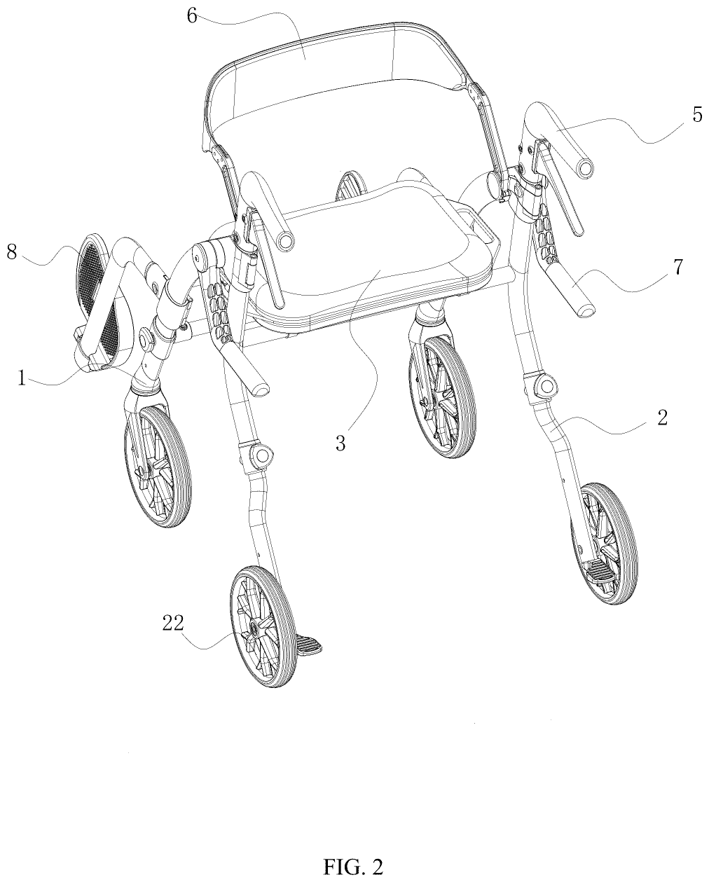

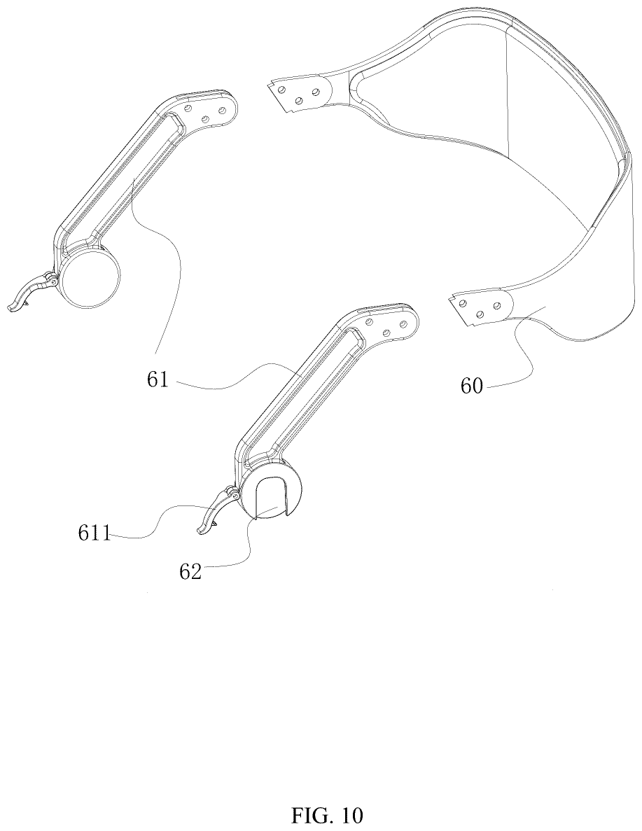

In an implementation, as shown in FIG. 10, the backrest assembly 6 includes a backrest 60 and a first installation part 61 provided at two ends of the backrest 60. The first installation part 61 is detachably connected to the backrest connection part 212, and in an implementation, the first slide rail 62 is provided on the first installation part 61. One end of the first installation part 61 away from the backrest 60 is further hinged with a first locking member 611, which can rotate around a hinge joint to fix the backrest assembly to the backrest connection part 212. The backrest connection part 212 is provided with a first locking groove 2122 configured for the first locking member 611 to insert corresponding to the first locking member 611. In an implementation, there are two first locking grooves 2122 that are symmetrically arranged. When the backrest needs to be changed, as shown in FIGS. 1 and 2, the backrest assembly 6 can be inserted in forward or reverse direction, and it is convenience of people with limited mobility, in an implementation, a connection way between the backrest and the first installation part includes but is not limited to a fastener connection, a plug-in connection or an elastic connection, which will not be further elaborated here.

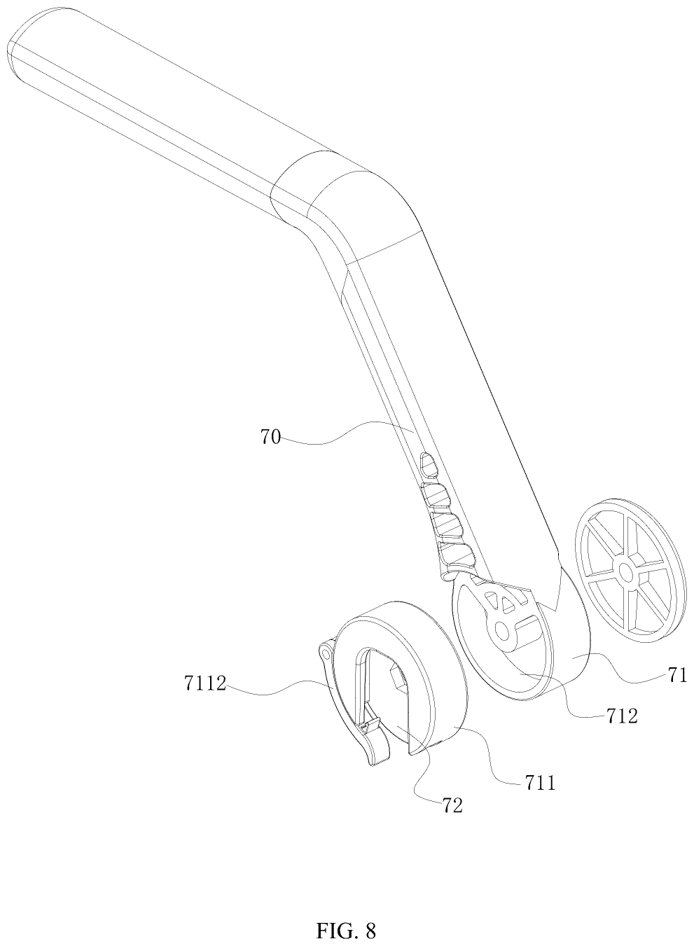

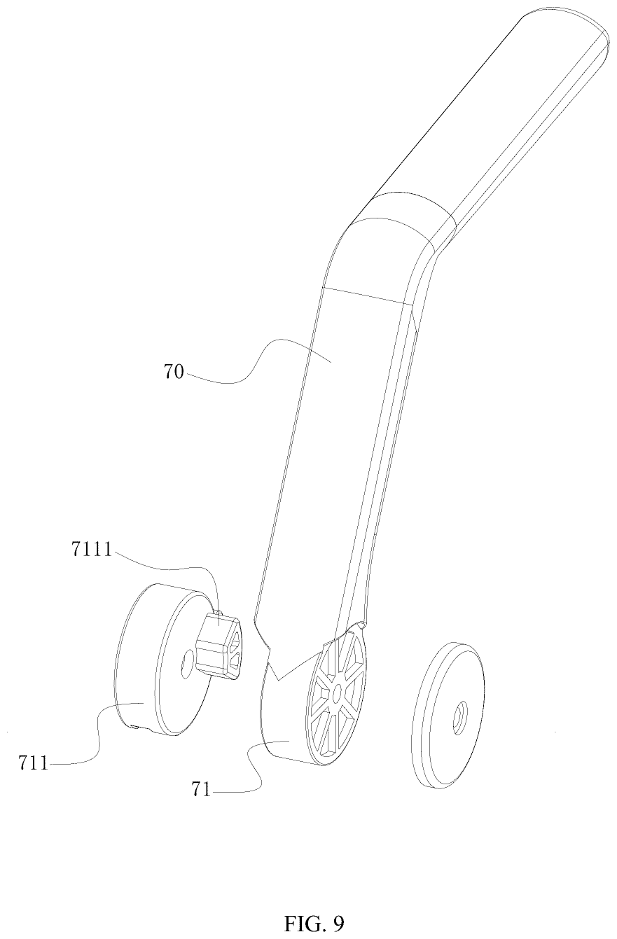

In an implementation, the armrest assembly 7 includes a handrail 70 and a second installation part 71 provided at one end of the handrail 70. The second installation part 71 is detachably connected to the armrest connection part 213. In an implementation, as shown in FIGS. 8 and 9, one side of the second installation part 71 close to the armrest connection part 213 is further provided with an insertion piece 711. And one side of the second installation part 71 away from the armrest connection part 213 is further provided with a cover plate. The insertion piece 711 is rotatably connected to the second installation part 71, and a limit slot 712 is provided on the second installation part 71. The insertion piece 711 is provided with a limit insertion piece 7111 corresponding to the limit slot 712, and the limit insertion piece 7111 can rotate within the limit slot 712. When the armrest assembly is in a state shown in FIG. 2, it can help people sitting elsewhere with limited mobility to stand up by supporting the armrest assembly, and an item can also be hung on the armrest.

In an implementation, the second slide rail 72 is provided on one side of the insertion piece 711 close to the armrest connection part, and the insertion piece 711 is further hinged with a second locking piece 7112. The armrest connection part 213 is provided with a second locking groove 2132 configured for the second locking piece 7112 to be inserted corresponding to the second locking piece 7112. When the second locking piece 7112 is inserted into the second locking groove 2132, the armrest assembly 7 can be fixed to the armrest connection part 213.

In an implementation, the front wheel bracket 1 is further provided with a foot pedal 8 configured for the user to step on, as shown in FIGS. 4, 5, and 12. The front wheel bracket 1 includes a front wheel frame body 10, a second roller 11 rotationally connected to one end of the front wheel frame body 10. A rotating member 12 is provided between the second roller 11 and the front wheel frame body 10, so that the second roller 11 can rotate along an axis of the rotating member 12. When it is needed to fold the rollator, the user lifts the seat assembly, and the first connection rod rotates upwards around the hinge joint. At the same time, the second connection rod is driven to rotate upwards around the hinge joint. During the folding process, the second roller will rotate 180° around the axis β of the rotating member and after folding, the rollator can park smoothly on the ground.

In an implementation, the foot pedal 8 is provided on one side of the front wheel frame body 10 away from the rear wheel bracket 2. The foot pedal 8 includes a fixed sleeve 80 sleeved on the front wheel frame body 10, a connection rod 81 provided on one end of the fixed sleeve 80, and a step piece 82 provided at one end of the connection rod 81 away from the fixed sleeve 80. The step piece 82 is hinged with the connection rod 81. As shown in FIG. 2, the step piece 82 can be flipped and folded around the hinge joint, thus it is convenient for the user to use and reduce occupied area.

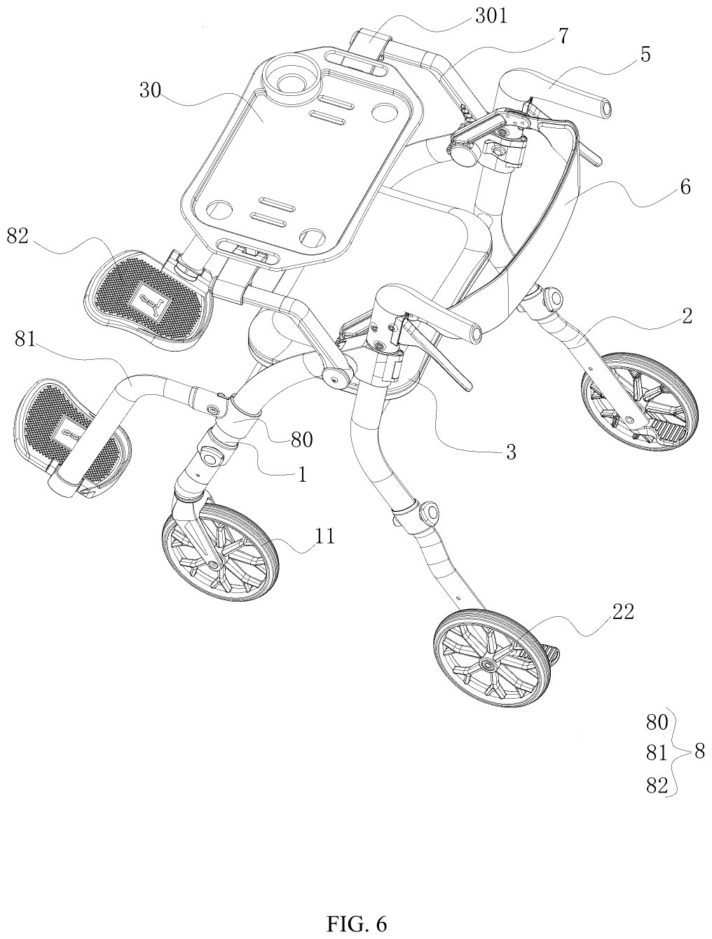

In an implementation, the seat assembly 3 further includes a dining plate 30 provided on the armrest assembly 7, and in an implementation, the seat assembly 3 further includes a cushion plate 31 provided on an upper of the installation plate 43, and a cushion 32 covered on an upper of the cushion plate 31. The dining plate 30 is detachably provided between the cushion 32 and the cushion plate 31, a lower of the dining plate 30 is hinged with a clamp connection piece 301. The dining plate 30 can be fixed to the cushion plate 31 through the clamp connection piece 301, as shown in FIG. 6, when the clamp connection piece 301 is unfolded, it can be placed on the handrail 70, and in an implementation, the clamp connection piece 301 is provided with a clamping part 302. The dining plate 30 and the cushion plate 31 are both provided with a clamping notch 303 that can be connected with the clamping part 302 to fix the dining plate 30 to the cushion plate 31. The clamping part 302 can also be clamped to the handrail 70 for convenient operation and use, thereby increasing a usage scenario of the rollator. In an implementation, a connection rod that is respectively connected to the cushion plate and armrest can be provided on the dining plate 30, which will not be further elaborated here.

The above is only a preferred embodiment of the present disclosure and is not intended to limit it. Any modifications, equivalent substitutions, and improvements made within the spirit and principles of the present disclosure shall be included within the protection scope of the present disclosure.

What is claimed is:

1. A rollator, comprising:
a front wheel bracket;
a rear wheel bracket;
at least one seat assembly, configured for a user to ride on; and
a connection mechanism connected between the front wheel bracket and rear wheel bracket, configured for the seat assembly to be detachably connected; wherein the seat assembly is capable of flipping around the connection mechanism to drive the front wheel bracket to move towards the rear wheel bracket and be folded onto the rear wheel bracket; the connection mechanism comprises a first connection rod, a second connection rod, and an installation plate; the first connection rod is hinged on the front wheel bracket; one end of the second connection rod is hinged on the rear wheel bracket and the other end thereof is hinged on the first connection rod; the installation plate is provided on the first connection rod and configured to connect the seat assembly; the first connection rod is driven to flip forward around the front wheel bracket by the seat assembly, and the second connection rod is driven to reverse backward to fold the front wheel bracket onto the rear wheel bracket by the seat assembly, the first connection rod abuts against the rear wheel bracket after being folded.

2. The rollator according to claim 1, wherein a length of the first connection rod is longer than a length of the second connection rod.

3. The rollator according to claim 1, wherein the rear wheel bracket comprises a rear wheel frame body, a first roller hinged on the rear wheel frame body, a connection kit sleeved on the rear wheel frame body and configured for the front wheel bracket to be hinged, and a handlebar assembly configured to be inserted forward or backward on the connection kit.

4. The rollator according to claim 3, wherein one side of the connection kit away from the front wheel bracket is hinged with a positioning member so as to lock the handlebar assembly, the handlebar assembly is provided with a plurality of positioning holes configured for the positioning member to insert; the connection kit is further provided with a through hole configured for the positioning member to pass through, and the positioning member runs through the through hole and is connected to the positioning holes; the connection kit comprises a hinge part configured for the front wheel bracket to be hinged and an insertion part configured for the handlebar assembly to pass through, wherein the handlebar assembly is capable to detachably insert onto the connection kit in forward or reverse direction and move up and down relative to the connection kit.

5. The rollator according to claim 3, further comprises a backrest assembly and an armrest assembly, two sides of the connection kit are further provided with a backrest connection part configured for the backrest assembly to be connected and an armrest connection part configured for the armrest assembly to be connected.

6. The rollator according to claim 5, wherein the backrest assembly comprises a backrest and a first installation part provided at two ends of the backrest, the first installation part is detachably connected to the backrest connection part.

7. The rollator according to claim 6, wherein the armrest assembly comprises a handrail and a second installation part provided at one end of the handrail, the second installation part is detachably connected to the armrest connection part.

8. The rollator according to claim 1, wherein the front wheel bracket is further provided with a foot pedal configured for the user to step on.

9. The rollator according to claim 5, wherein the seat assembly further comprises a dining plate provided on the armrest assembly.

10. The rollator according to claim 9, wherein the seat assembly further comprises a cushion plate provided on an upper of the installation plate, and a cushion covered on an upper of the cushion plate, wherein the dining plate is detachably provided between the cushion and the cushion plate.
